(19) United States
(12) Patent Application Publication
(10) Pub. No.: US 2011/0011084 A1
(43) Pub. Date: Jan. 20, 2011

(54) EXHAUST GAS RECIRCULATION SYSTEM FOR INTERNAL COMBUSTION ENGINE

(75) Inventors: Etsugou Yanagida, Kariya-city (JP); Yoshitaka Nishio, Nagoya-city (JP); Yoshiaki Yamamoto, Anjo-city (JP); Kiyoshi Ooshima, Anjo-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/835,839

(22) Filed: Jul. 14, 2010

(30) Foreign Application Priority Data
Jul. 16, 2009 (JP) 2009-168037
Jul. 27, 2009 (JP) 2009-174046
Jul. 30, 2009 (JP) 2009-177593

(51) Int. Cl. F02M 25/07; F02B 33/34

(52) U.S. Cl. 60/605.2

(57) ABSTRACT

An EGR system includes an exhaust gas recirculation pipe recirculating exhaust gas flowing through an exhaust pipe into an intake pipe upstream of a compressor of a supercharger. A swirling flow generator generates a swirling flow of intake air and exhaust gas along an inner surface of the intake pipe in order to centrifugally separate foreign matters from the intake air and the exhaust gas. A foreign-matters-collecting chamber collects the centrifugally separated solid foreign matters therein. The separated solid foreign matters are discharged through a discharge opening and a discharge pipe.

### CROSS-REFERENCE TO RELATED APPLICATION

This application is based on Japanese Patent Applications No, 2009-168037 filed on Jul. 16, 2009, No. 2009-177593 filed on Jul. 30, 2009, No. 2009-174046 filed on Jul. 27, 2009, the disclosures of which are incorporated herein by reference.

### FIELD OF THE INVENTION

The present invention relates to an exhaust gas recirculation system for an internal combustion engine, which recirculates a part of exhaust gas flowing through an exhaust passage downstream of a turbine of a turbocharger into an intake passage upstream of a compressor. Especially, in this system, the exhaust gas introduced into the intake passage is swirled in the intake passage. Its centrifugal force separates foreign matters (particulate matters) contained in the exhaust gas therefrom.

### BACKGROUND OF THE INVENTION

It is well known that an exhaust gas recirculation system (EGR system) for a diesel engine equipped with a turbocharger. In this EGR system, a part of an exhaust gas (EGR gas) is recirculated from an exhaust passage into an intake passage. The EGR gas is filtrated into a clean air by an air clearer so that the cleaned air is introduced into a scroll chamber of a compressor housing of the turbocharger. By recirculating the EGR gas which contains H₂O, CO₂, etc., a combustion temperature is decreased, whereby nitrogen oxides (NOx) are reduced.

Also, as shown in FIGS. 8 and 9, a low pressure loop-EGR system (LPL-EGR system) is well known. In this LPL-EGR system, an EGR-gas pipe 24 defining an exhaust gas recirculation passage 101 introduces an EGR gas from an exhaust passage downstream of a scroll chamber 16 of a turbine housing 12 into an intake passage 102 upstream of a scroll chamber 17 of a compressor housing 14 of a turbocharger.

The EGR-gas pipe 24 is connected to an intake pipe 8 which defines the intake passage 102 therein. Moreover, an air cleaner 4 is provided in the intake pipe 8, and a low-pressure EGR control valve 27 is provided in the EGR-gas pipe 24. The low-pressure EGR control valve 27 adjusts a mount of the EGR gas flowing therethrough.

In the LPL-EGR system, since the EGR gas is introduced into the intake passage 102 upstream of the scroll chamber 17, it is likely that foreign matters (broken pieces of the DPF, carbon particulates, water drop, spatter, etc.) contained in the EGR gas may flow into the compressor along with a mixture of the intake air and the EGR gas.

It should be noted that if the foreign matters collide with a compressor wheel 13 of the turbocharger, the compressor wheel 13 may be damaged.

In order to prevent a damage of the compressor wheel 13, it is necessary to separate the foreign matters contained in the EGR gas at an upstream from the scroll chamber 17 of the compressor housing 14.

JP-2009-041551A shows a LPL-EGR system equipped with a condensed water collecting mechanism which collects the condensed water in order to prevent a corrosion of the compressor wheel 13 or the intake pipe 8 due to the condensed water in the EGR gas.

However, in this LPL-EGR system, although the condensed water can be collected, the other solid foreign matters can not be collected.

JP-2009-024692A shows another LPL-EGR system having a cylindrical guide portion which introduces the EGR gas into a center portion of a compressor.

However, even in this LPL-EGR system, it is likely that solid foreign matters collide with the compressor, which may damages the compressor.

In the LPL-EGR system shown in FIG. 8, a diesel particulate filter (DPF) 7 is provided in the exhaust pipe downstream of the scroll chamber 16 of the turbine housing 12 in order to capture diesel particulate matters (PM).

The DPF 7 is heated by a heater or a post fuel injection in order to burn the captured diesel PM. When a lot of diesel PM are burned rapidly, the temperature of the DPF 7 rises excessively, which may cause damages (melting or crack) of the DPF 7. If a broken piece of the DPF 7 is recirculated into the compressor wheel 13, the broken piece collides with the compressor wheel 13, which may cause a damage of the compressor wheel 13.

### SUMMARY OF THE INVENTION

The present invention is made in view of the above matters, and it is an object of the present invention to provide an exhaust gas recirculation system for an internal combustion engine, which is capable of restricting a damage of a compressor due to a collision of foreign matters contained in an exhaust gas.

According to the present invention, an exhaust gas recirculation system includes an intake pipe for introducing an intake air into a combustion chamber of the engine, an exhaust pipe for introducing an exhaust gas emitted from the engine, an exhaust gas recirculation pipe recirculating the exhaust gas flowing through the exhaust pipe into the intake pipe upstream of the compressor of the supercharger. A swirling flow generator is provided to an intake pipe for generating a swirling flow of the intake air and the exhaust gas along an inner surface of the intake pipe in order to centrifugally separate solid foreign matters from the intake air and the exhaust gas. A foreign-matters-collecting chamber collects the centrifugally separated solid foreign matters therein. A discharge means discharges the separated solid foreign matters from the foreign-matters-collecting chamber.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1 is a schematic view showing an essential portion of a LPL-EGR system according to a first embodiment;

FIGS. 2A and 2B are sectional views of a swirling flow generator according to the first embodiment;

FIGS. 3A and 3B are sectional views of a swirling flow generator according to a second embodiment;

FIGS. 4A and 4B are sectional views of a swirling flow generator according to a third embodiment;

FIG. 5 is a schematic view showing an essential portion of a LPL-EGR system according to a fourth embodiment;

FIG. 6A is a schematic view showing an essential portion of a LPL-EGR system according to a fifth embodiment;

FIG. 6B is a cross sectional view taken along a line VIB-VIB;

FIG. 7A is a schematic view showing an essential portion of a LPL-EGR system according to a sixth embodiment;

FIG. 7B is a cross sectional view taken along a line VIIB-VIIB;

FIG. 8 is a schematic view of a conventional engine control system;

FIG. 9 is a schematic view showing an essential portion of a conventional LPL-EGR system;

FIG. 10 is a schematic view showing an essential portion of a LPL-EGR system according to a seventh embodiment;

FIG. 11 is a schematic view showing an essential portion of a LPL-EGR system according to an eighth embodiment;

FIG. 12 is a schematic view showing an essential portion of a LPL-EGR system according to a ninth embodiment;

FIG. 13 is a schematic perspective view showing a swirling flow generator according to a tenth embodiment;

FIG. 14 is a view in a direction of an arrow XIV in FIG. 13;

FIG. 15 is a cross sectional view taken along a line XV-XV in FIG. 14;

FIG. 16 is a schematic perspective view showing a swirling flow generator according to an eleventh embodiment;

FIG. 17 is a schematic perspective view showing a swirling flow generator according to a twelfth embodiment; and

FIG. 18 is a view in a direction of an arrow XVIII in FIG. 17.

### DETAILED DESCRIPTION OF EMBODIMENTS

Hereafter, embodiments of the present invention will be described.

### First Embodiment

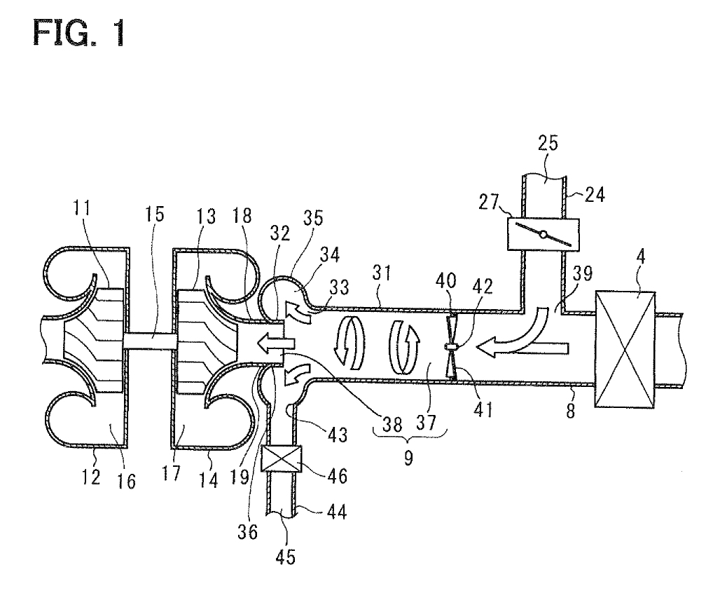

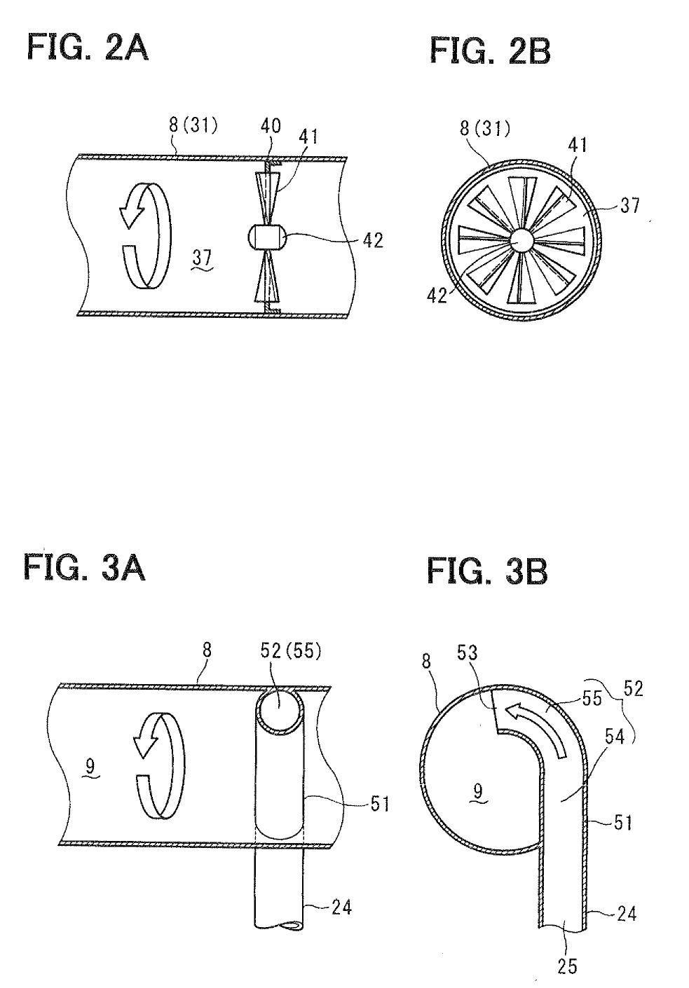

FIGS. 1, 2A and 2B show a first embodiment of the present invention. FIG. 1 shows an essential part of a low pressure loop (LPL)-EGR system, and FIGS. 2A and 2B show a swirling flow generator.

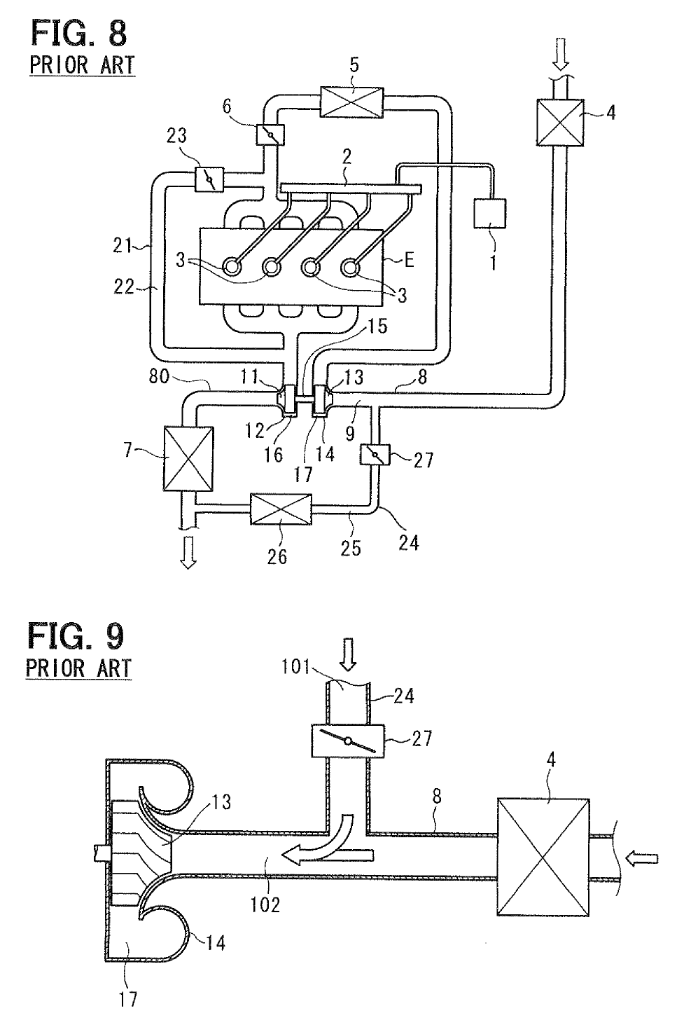

According to the present embodiment, an engine control system includes an EGR system and an electronic control unit (ECU). The conventionally common parts and components will be explained based on FIG. 8.

An engine “E” is a diesel engine having four cylinders, a cylinder block, an intake manifold, an exhaust manifold, and a cylinder head. Four combustion chambers are formed in corresponding cylinder. A piston connected through a connecting rod to a crank shaft is slidably supported in a cylinder bore formed inside the cylinder block.

The engine “E” has four intake ports and four intake valves. An intake pipe 8 forming an intake passage 102 is connected to each intake port. The engine “E” has four exhaust ports and four exhaust valves. Each exhaust port is connected to an exhaust pipe 80 forming an exhaust passage.

A fuel injection system is a common rail fuel injection system. This common rail fuel injection system includes a supply pump 1 pumping up fuel from a fuel tank, a common rail 2 accumulating the fuel of high pressure, and four fuel injectors injecting high pressure fuel into the combustion chamber of each cylinder. The quantity of the fuel discharged from the supply pump 1 and valve opening timing of the injector 3 are controlled by the ECU.

The intake pipe 8 is provided with an air cleaner 4, a swirling flow generator which will be described later, a compressor wheel 13 of the turbocharger, an intercooler 5, and a throttle valve 6.

The exhaust pipe 80 defines an exhaust passage through which exhaust gas is discharged from the combustion chamber. The exhaust pipe 80 is provided with a turbine 11 and a diesel particulate filter (DPF) 7.

The DPF 7 has a well known structure made from ceramics. The exhaust gas discharged from engine “E” flows through the DPF 7 and the diesel PM are accumulated on the DPF 7. Also, an oxidation catalyst (DOC) may be provided in the exhaust pipe 80 upstream of the DPF 7. The DOC has a well known structure.

The turbocharger is comprised of a turbine 11, a compressor wheel 13 and a rotor shaft 15, as shown in FIG. 1. The turbine 11 is accommodated in a turbine housing 12. The compressor wheel 13 is accommodated in a compressor housing 14.

The rotor shaft 15 connects the turbine 11 and the compressor wheel 13. The turbine 11 and the compressor wheel 13 rotate together with each other. The turbine housing 12 defines a first scroll chamber 16 which accommodates the turbine 11 therein. The first scroll chamber 16 includes a first spiral fluid passage (scroll passage) around the turbine 11.

An upstream end of the first spiral fluid passage is connected to the exhaust pipe 80. A downstream end of the first spiral fluid passage is also connected to the exhaust pipe 80.

The compressor housing 14 defines a second scroll chamber 17 which accommodates the compressor wheel 13. The second scroll chamber 17 includes a second spiral fluid passage (scroll passage) around the compressor wheel 13. An upstream end of the second spiral fluid passage forms an inlet 18 through which the intake air or the mixture gas flows into the second scroll chamber 17. A connecting pipe 19 connects the inlet 18 and the intake pipe 8. A downstream end of the second spiral fluid passage forms an outlet through which the compressed air flows out toward the intercooler 5.

According to the present embodiment, the EGR system is comprised of the low-pressure loop (LPL)-EGR system and the high-pressure loop (HPL)-EGR system.

The HPL-EGR system includes a HPL-EGR gas pipe 21 defining a HPL-EGR passage 22 through which the high pressure exhaust gas is circulated from the exhaust pipe 80 to the intake pipe 8. The HPL-EGR passage 22 fluidly connects an upstream of the turbine 11 in the exhaust pipe 80 and a downstream of the throttle valve 6 in the intake pipe 8. The HPL-EGR gas pipe 21 is provided with a HPL-EGR cooler (not shown) and a HPL-EGR control valve 23 which adjusts a quantity of the EGR gas flowing through the HPL-EGR passage 22. The HPL-EGR cooler is not always necessary.

The LPL-EGR system includes a LPL-EGR gas pipe 24 defining a LPL-EGR passage 25. The exhaust gas flowing downstream of the DPF 7 is introduced into an intake passage 9 upstream of the compressor wheel 13. The LPL-EGR gas pipe 24 is provided with a LPL-EGR cooler 26 and a LPL-EGR control valve 27 which adjusts a quantity of the EGR gas flowing through the LPL-EGR passage 25. The LPL-EGR cooler 26 is not always necessary.

The intake pipe 8 is comprised of a first intake pipe 31 and a second intake pipe 32. Their passage sectional areas are different from each other. The first intake pipe 31 is arranged upstream of the second intake pipe 32. The passage sectional area of the first intake pipe 31 is larger than that of the second intake pipe 32. A tank case 35 is formed between the first intake pipe 31 and the second intake pipe 32. The tank case 35 defines a foreign-matters-collecting chamber 34 therein. The second intake pipe 32 includes a connecting portion 36 which is connected to the connecting pipe 19. The inner diameter of the first intake pipe 31 is larger than those of the inlet 18 and the second intake pipe 32.

The intake passage 9 is comprised of a first intake passage 37 defined by the first intake pipe 31 and a second intake passage 38 defined by the second intake pipe 32. The first intake pipe 31 has an EGR-gas introducing port 39 to which the LPL-EGR gas pipe 24 is connected. The EGR gas flowing thorough the LPL-EGR passage 25 flows into the first intake passage 37.

The intake pipe 8 is provided with a swirling flow generator, an annular step portion formed around the connecting portion 36, and a foreign matters collecting portion. The swirling flow generator is comprised of a disc plate 40 attached to an inner wall of the first intake pipe 31, a plurality of fixed swirlers 41 and a supporting shaft 42 supporting the fixed swirlers 41. The fixed swirlers 41 generate swirling flows along the inner surface of the first intake pipe 31. The swirlers 41 are formed by cutting the disc plate 40 into polygonal shaped pieces. These polygonal shaped pieces are bended in upstream and downstream directions in the first intake passage 37. The supporting shaft 42 is arranged at a center of the first intake passage 37.

The foreign-matters-collecting chamber 34 has an annular opening 33 between the first intake pipe 31 and the second intake pipe 32. The foreign-matters-collecting chamber 34 and the annular opening 33 correspond to a step portion between the first intake pipe 31 and the second intake pipe 32.

As described above, the mixture of air and EGR gas is swirled by the fixed swirlers 41, whereby solid foreign matters are centrifugally separated from the gas by its centrifugal force. The separated solid foreign matters flow along the inner surface of the first intake pipe 31 and flow into the foreign-matters-collecting chamber 34 through the opening 33.

It should be noted that the tank case 35 has a curved-surface and the foreign-matters-collecting chamber 34 is doughnut-shaped.

The tank case 35 has a discharge opening 43 to which a discharge pipe 44 is connected. The discharge opening 43 is arranged at a bottom surface of the tank case 35 in the gravity direction. A collecting box (not shown) is connected to the other end of the discharge pipe 44. Instead of the collecting box, the exhaust pipe 80 can be connected to the collecting box. A check valve 46 preventing a reverse flow of the EGR gas is disposed in the discharge pipe 44. A foreign matters discharge mechanism is comprised of the discharge opening 43, the discharge pipe 44 and the check valve 46. The centrifugally separated solid foreign matters are discharged from the intake pipe 8 through the discharge pipe 44.

Referring to FIGS. 1 and 2, an operation of the engine control system will be described. The exhaust gas discharged from the engine “E” is introduced into the first scroll chamber 16. This introduced exhaust gas rotates the turbine 11 around the shaft 15, Then, the exhaust gas flows through the DPF 7 to be discharged out from the engine “E”.

The compressor wheel 13 is also rotated along with the turbine 11 through the shaft 15. The compressor wheel 13 compresses the intake air (and the EGR gas). The compressed air (and the EGR gas) is supercharged into a combustion chamber of each cylinder through the intercooler 5 and the throttle valve 6.

When the LPL-EGR control valve 27 is opened, the exhaust gas flowing through the exhaust pipe 80 flows into the first intake passage 37 through the LPL-EGR passage 25. The intake air and the EGR gas is mixed together in the first intake passage 37. When this air-gas mixture flows through the fixed swirlers 41, the air-gas mixture is swirled.

The solid foreign matters, such as carbon particulates, condensed water and fragments of DPF 7, contained in the EGR gas have larger specific gravity than the air-gas mixture. Thus. these solid foreign matters are centrifugally separated from the air-gas mixture.

The separated solid foreign matters flow into the foreign-matters-collecting chamber 34 through the opening 33. The solid foreign matters are also swirled along an inner surface of the tank case 35, and drop to the bottom surface of the tank case 35. Then, the solid foreign matters are discharged into the collecting box (not shown) through the discharge pipe 44.

According to the present embodiment, the solid foreign matters can be centrifugally separated from the air-gas mixture, so that the solid foreign matters hardly flow into the compressor. The compressor is hardly damaged.

The solid foreign matters can be discharged into the exhaust pipe 80 through the discharge pipe 44. In such a case, it is not always necessary that the discharge opening 43 is arranged on the bottom surface of the tank case 35. The discharge opening 43 can be formed at any circumferential position of the tank case 35. Alternatively, the separated solid foreign matters can be introduced into the intake pipe 8 downstream of the compressor wheel 13.

### Second Embodiment

In the second and the successive embodiments, the same parts and components as those in the first embodiment are indicated with the same reference numerals and the same descriptions will not be reiterated. FIGS. 3A and 3B show a swirling flow generator according to a second embodiment.

The intake pipe 8 is provided with an EGR introducing pipe 51 connected to the LPL-EGR gas pipe 24. The EGR introducing pipe 51 defines an EGR introducing passage 52 which communicates with the LPL-EGR passage 25, The EGR introducing passage 52 has an EGR introducing port 53 which opens in the intake passage 9. In the present embodiment, the EGR introducing passage 52 corresponds to the swirling flow generator. The EGR introducing passage 52 is comprised of a straight passage 54 and a curved passage 55. The straight passage 54 extends in a tangential direction of an inner wall of the intake pipe 8. The curved passage 55 extends in a circumferential direction of the intake pipe 8 along its inner wall. The EGR introducing passage 52 introduces the EGR gas in a tangential direction of the inner wall of the intake pipe 8.

The LPL-EGR gas introduced into the intake passage 9 through the LPL-EGR passage 25 and the EGR introducing passage 52 is swirled along an inner surface of the intake pipe 8. The solid foreign matters contained in the LPL-EGR gas are centrifugally separated from the EGR gas.

### Third Embodiment

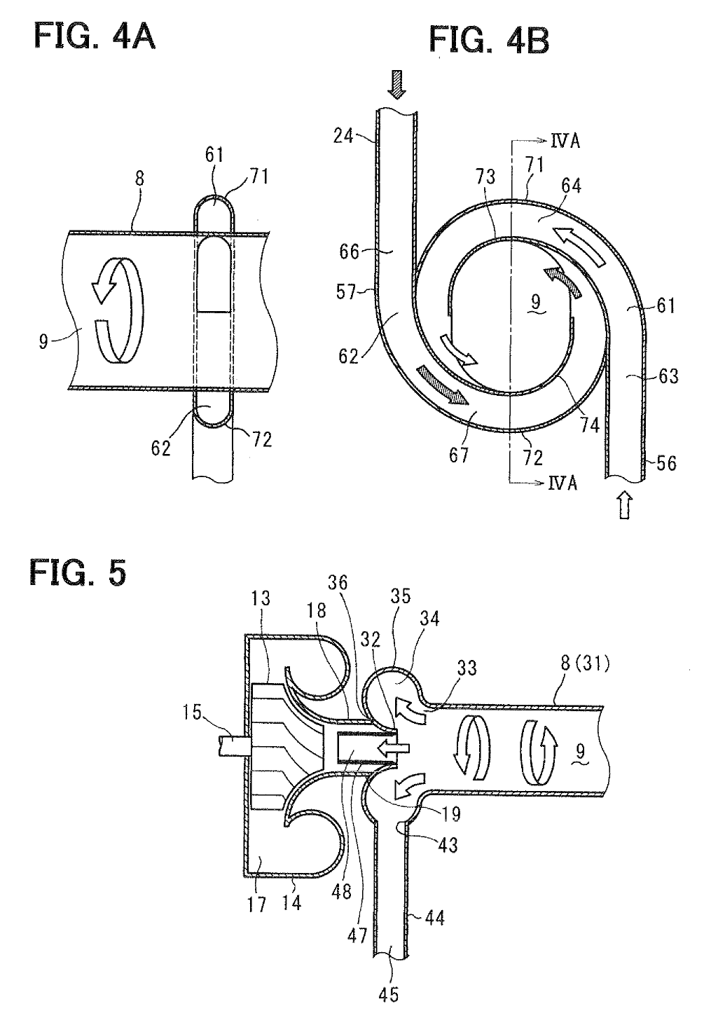

FIGS. 4A and 4B show a swirling flow generator according to a third embodiment. A first introducing pipe 56 and a second introducing pipe 57 are fluidly connected to the intake pipe 8. The first introducing pipe 56 is branched from the intake pipe 8 downstream of the air cleaner 4. The second introducing pipe 57 is connected to the LPL-EGR gas pipe 24.

The first introducing pipe 56 defines a first introducing passage 61 for introducing the intake air into the intake pipe 8 in a tangential direction of the inner wall of the intake pipe 8. The second introducing pipe 57 defines a second introducing passage 62 for introducing the EGR gas into the intake pipe in the tangential direction.

The first introducing passage 61 is comprised of a first straight passage 63 and a first curved passage 64 which circumferentially extends along the inner wall surface of the intake pipe 8.

The second introducing passage 62 is comprised of a second straight passage 66 and a second curved passage 67 which circumferentially extends along the inner wall surface of the intake pipe 8.

A first outer wall 71 and a first inner wall 73 define the first curved passage 64, and a second outer wall 72 and a second inner wall 74 defines the second curved passage 67. The first inner wall 73 has a smaller curvature radius than the first outer wall 71 and the second outer wall 72. The first inner wall 73 is continuously connected to the intake pipe 8.

The second inner wall 74 has a smaller curvature radius than the first outer wall 71 and the second outer wall 72. The second inner wall 74 is continuously connected to the intake pipe 8. The curvature radius of the first curved passage 64 gradually decreases. Also, the curvature radius of the second curved passage 67 gradually decreases.

### Fourth Embodiment

FIG. 5 shows an essential part of a LPL-EGR system according to a fourth embodiment. The intake pipe 8 is provided with a tank case 35 and a swirling flow generator which is similar to the first to third embodiment. A cylindrical guide pipe 47 is arranged in the inlet 18. The cylindrical guide pipe 47 defines a guide passage 48 which introduces the intake air and the EGR gas into a center of the compressor wheel 13.

A passage sectional area of the guide pipe 47 is smaller than that of the inlet 18. The inlet 18 and the guide pipe 47 are coaxial to each other. The solid foreign matters which were not centrifugally separated are introduced into a center of the compressor wheel 13 through the guide pipe 47.

Even if the solid foreign matters were not centrifugally separated enough, the solid foreign matters collide with the center of the compressor wheel 13. Thus, it is avoided that the solid foreign matters collide with outer peripheral portions of compressors of which circumferential speed is relatively high, whereby a damage of the compressor wheel 13 can be restricted.

### Fifth Embodiment

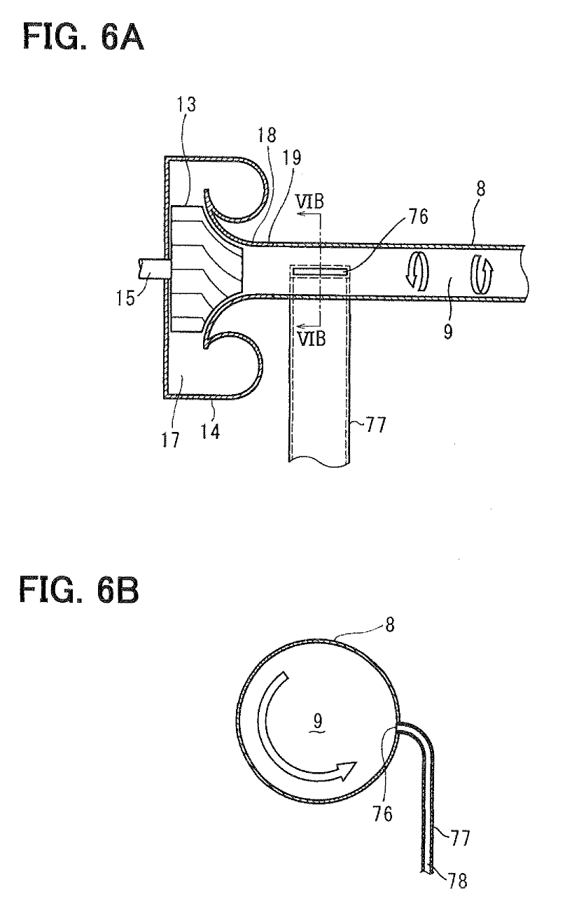

FIGS. 6A and 6B show an essential part of a LPL-EGR system according to a fifth embodiment. The intake pipe 8 is provided with a swirling flow generator which is similar to the first to third embodiment. The centrifugally separated solid foreign matters flow along an inner wall surface of the intake pipe 8.

The intake pipe 8 is provided with a discharge slit 76 to which a foreign-matter discharge pipe 77 is connected. The foreign-matter discharge pipe 77 defines a foreign-matter discharge passage 78 therein. The other end of the foreign-matter discharge pipe 77 is connected to a foreign-matters collecting box (not shown) or the exhaust pipe. A check valve may be provided in the foreign-matter discharge pipe 77. The solid foreign matters are discharged out of the engine “E” through the discharge slit 76, the foreign-matter discharge pipe 77 and the check valve.

Thus, the mixture of the intake air and the EGR gas which scarcely contains the solid foreign matters can be introduced into the second scroll chamber 17. It can be restricted that the compressor wheel 13 is damaged by the solid foreign matters.

It should be noted that the discharge slit 76 can be positioned at any place in a circumferential direction of the inner wall of the intake pipe 8. Moreover, the centrifugally separated foreign matters can be introduced into the intake pipe downstream of the compressor wheel 13.

### Sixth Embodiment

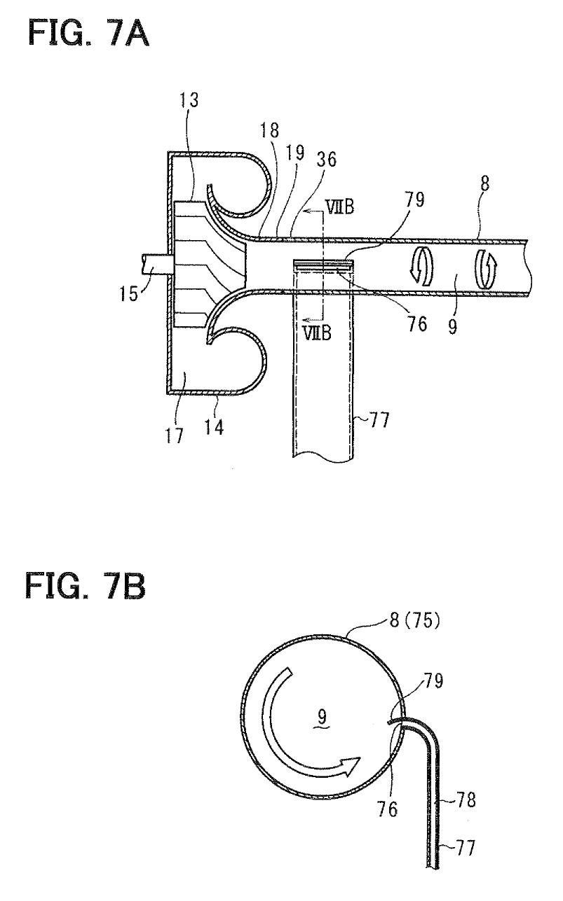

FIG. 7 shows an essential part of a LPL-EGR system according to a sixth embodiment. In the present embodiment, a guide plate 79 is disposed at a fringe of the discharge slit 76. This guide plate 79 is opposed to a swirling flow of the solid foreign matters. Thus, the swirling solid foreign matters collide with the guide plate 79 to be introduced into the discharge slot 76.

### Modification

The swirling flow generator can be arranged in the LPL-EGR gas pipe 24. A gasoline engine can be used as the internal combustion engine “E”. Further, not only the multi-cylinder engine but also a single-cylinder engine may be used as the internal combustion engine “E”.

The turbocharger may be equipped with an assist motor. Alternatively, instead of the turbocharger, a supercharger with an electric motor can be used.

In the above embodiment, a bypass passage can be provided for bypassing the HPL-EGR cooler and/or the LPL-EGR cooler.

### Seventh Embodiment

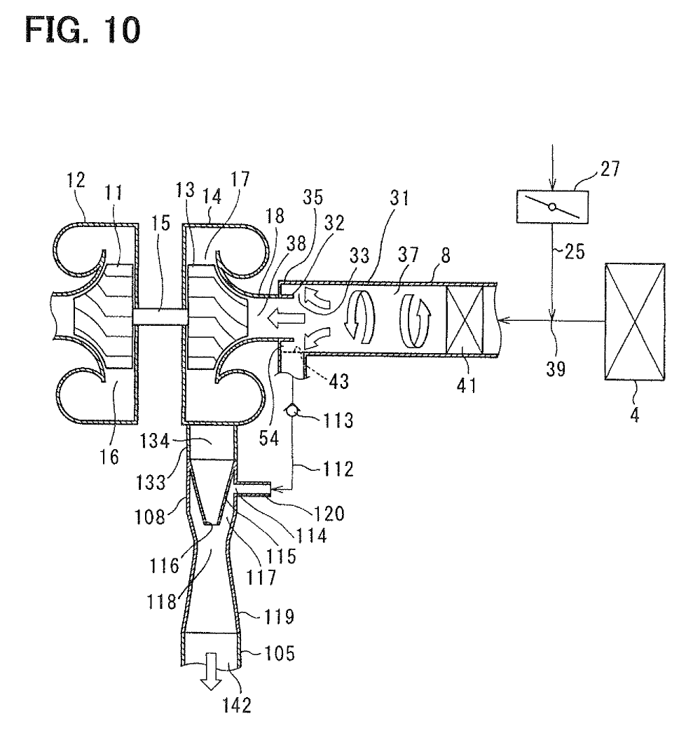

FIG. 10 shows an essential part of a low pressure loop (LPL)-EGR system according to a seventh embodiment.

In the present embodiment, the centrifugally separated foreign matters are introduced into a bypass pipe 120 through the discharge opening 43. The bypass pipe 120 defines a bypass passage 112 which bypasses the compressor wheel 13 and communicates with an ejector 108 provided to a third intake pipe 105.

A foreign matters discharge apparatus is comprised of the ejector 108 and the bypass passage 12.

The ejector 108 is arranged between an outlet 133 of the compressor housing 14 and an upstream end of the third intake pipe 105. The outlet 133 defines a compressed air discharge passage 134.

The ejector 108 includes a nozzle 115, a negative pressure generating portion 117, a mixing portion 118 and a diffuser 119. The nozzle 115 has a throttle 116. When the compressed air flows through the throttle 116, a negative pressure is generated in the negative pressure generating portion 117. This negative pressure suctions the foreign matters through the bypass passage 112. The suctioned foreign matters and the air passed through the throttle 116 are mixed in the mixing portion 118. Then, the mixture of the foreign matters and the air flows into the diffuser 119 in which its pressure is increased.

The nozzle 115, the mixing portion 118, and the diffuser 119 are coaxially arranged in the ejector 108.

It should be noted that the ejector 108 is connected to the third intake pipe 105 defining a third intake passage 142 which communicates with the combustion chamber of each cylinder.

When the air flows through the throttle 116, its flowing velocity is increased, so that a negative pressure is generated in the negative pressure generating portion 117 according to the Venturi Effect.

The bypass pipe 120 fluidly connects the discharge opening 43 and the negative pressure generating portion 117 while bypassing the scroll chamber 17. A suction port 114 is formed around the nozzle 115, to which the bypass pipe 120 is connected.

A check valve 113 is provided in the bypass passage 112, which allows a fluid flow in a direction from the discharge opening 43 to the suction port 114.

According to the present embodiment, the foreign matters, such as condensed water containing acid foreign matters, can be introduced into the combustion chamber with the compressed air while bypassing the compressor of the turbo charger. Thus, it is prevented that the acid condensed water is discharged outside of the vehicle.

Further, all of the EGR gas regulated by the EGR control valve 27 can be recirculated into the combustion chamber. Thus, an actual EGR ratio in the combustion chamber hardly deviates from the target EGR ratio.

Moreover, it is restricted that the compressor housing 26 made of aluminum material is corroded by the acid condensed water. The foreign matters can be introduced into the combustion chamber promptly by the ejector 108.

### Eighth Embodiment

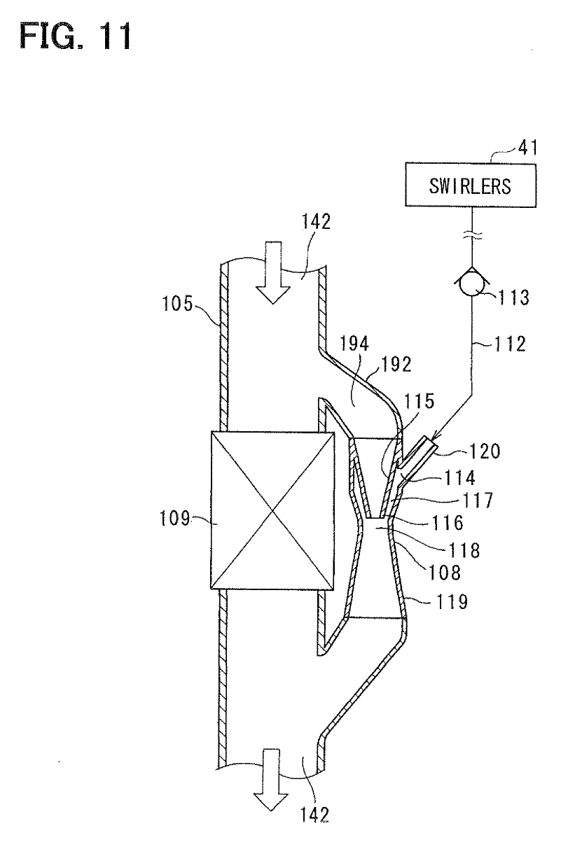

FIG. 11 shows an essential part of a LPL-EGR system according to an eighth embodiment.

An intercooler 109 is provided in the third intake pipe 105. The intercooler 109 cools the compressed air flowing through the third intake passage 142. A second bypass pipe 192 bypassing the intercooler 109 is provided to the third intake pipe 105. This second bypass pipe 192 defines a second bypass passage 194 therein.

In this second bypass pipe 192, the ejector 108 is provided.

This ejector 108 has almost the same configuration as the seventh embodiment.

A part of the compressed air flows into the second bypass passage 194 to generate a negative pressure so that the centrifugally separated foreign matters are suctioned into the negative pressure generating portion 117. The other compressed air flows into the intercooler 109 to be cooled. The intercooler 109 has a well known conventional configuration made of aluminum material.

Since acid condensed water containing foreign matters bypasses the compressor wheel 13 and the intercooler 109, it is restricted that the compressor wheel 13 and the intercooler are corroded.

### Ninth Embodiment

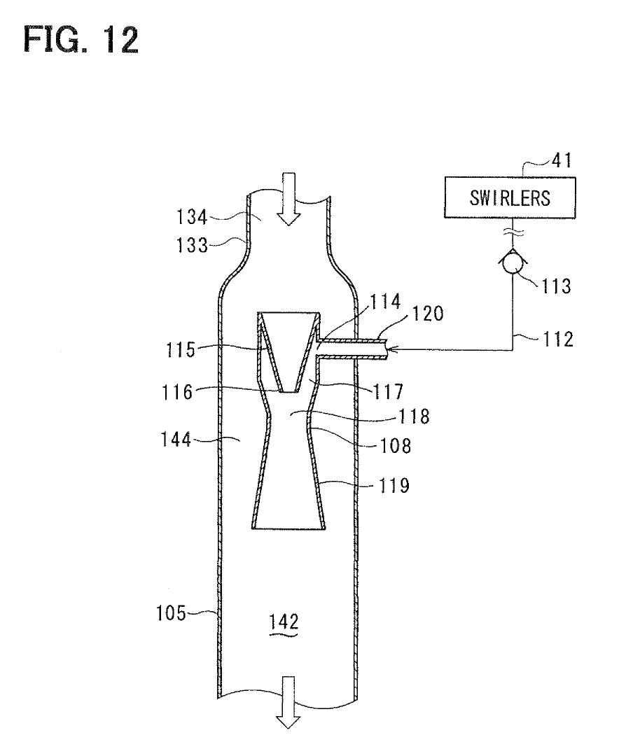

FIG. 12 shows an essential part of a LPL-EGR system according to a sixth embodiment.

The ejector 108 is disposed in the third intake passage 142 in such a manner as to define an annular passage 144 between an outer wall of the ejector 108 and an inner wall of the third intake pipe 105.

A flow passage area of the annular passage 144 is greater than or equal to a flow passage area of the compressed air discharge passage 134 of the outlet 133. Thus, even though the ejector 108 is provided in the third intake passage 142, a pressure loss due to the ejector 108 can be avoided.

### Tenth Embodiment

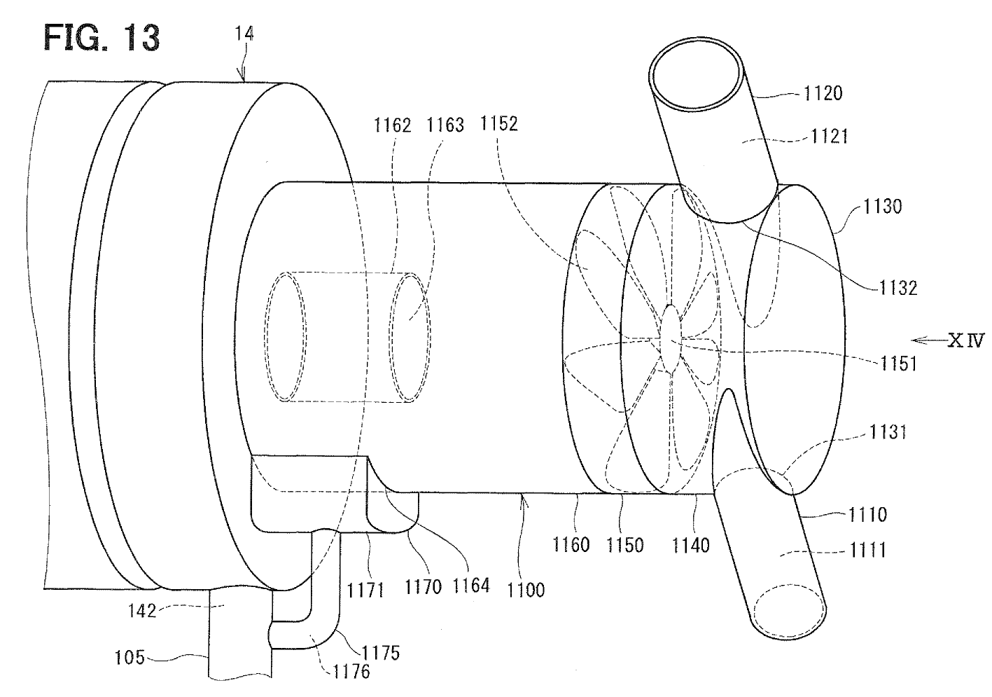

Referring to FIGS. 13 to 15, a swirling flow generator 1100 will be described. The swirling flow generator 1100 includes an exhaust gas introducing pipe 1110, an intake air introducing pipe 1120, a cylindrical portion 1130, and a collecting chamber 1170. In this embodiment, the swirling flow generator 1100 is made of resin material.

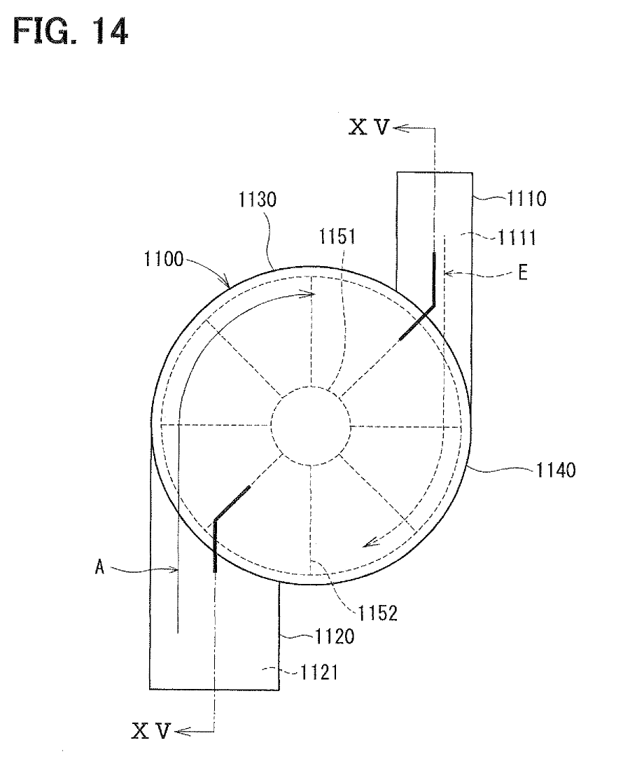

The exhaust gas introducing pipe 1110 defines an LPL-EGR gas introducing passage 1111. One end of the exhaust gas introducing pipe 1110 is fluidly connected to an opening 1131 of the cylindrical portion 1130, The other end of the exhaust gas introducing pipe 1110 fluidly communicates with the LPL-EGR passage 25. The intake air introducing pipe 1120 has a larger flow passage area than the exhaust gas introducing pipe 1110. One end of the intake air introducing pipe 1120 is connected to an opening 1132 of the cylindrical portion 1130 and the other end fluidly communicates with the intake pipe 8 provided with the air cleaner 4. The intake air introducing pipe 1120 defines an intake air introducing passage 1121. As shown in FIG. 14, the exhaust gas introducing pipe 1110 and the intake air introducing pipe 1120 are tangentially provided to the cylindrical portion 1130.

As shown in FIGS, 13 and 15, the cylindrical portion 1130 is comprised of an introducing portion 1140, a blade portion 1150, and a mixing portion 1160. The introducing portion 1140 is cup-shaped. The openings 1131, 1132 are formed in a circumferential wall of the introducing portion 1140.

The blade portion 1150 is continuously connected to the introducing portion 1140. The blade portion 1150 includes a center axis 1151 of which cross-section is U-shaped and a plurality of guide blades 1152. The guide blades 1152 radially extend from the center axis 1151. Also, the center axis 1151 has a plurality of ribs 1153 for reinforcing the guide blades 1152. The blade portion 1150 including the above parts is integrally molded.

In the present embodiment, eight guide blades 1152 are provided. The number of the guide blades 1152 and their shape are design factors.

The mixing portion 1160 is a cylindrical cup having an end portion 1161. A communication pipe 1162 defining a communication passage 1163 is provided to the end portion 1161 in such a manner as to penetrate the end portion 1161. The mixing portion 1160 has a discharge opening 1164 at its circumferential wall. The collecting chamber 1170 is defined around the discharge opening 1164.

The collecting chamber 1170 is formed circumferentially outside of the mixing portion 1160. The centrifugally separated foreign matters are collected into the collecting chamber 1170. A discharge pipe 1175 defining a discharge passage 1176 is connected to a bottom wall 1171 of the collecting chamber 1170. The other end of the discharge pipe 1175 is fluidly connected to the intake pipe 105 downstream of the compressor wheel 13 accommodated in the compressor housing 14.

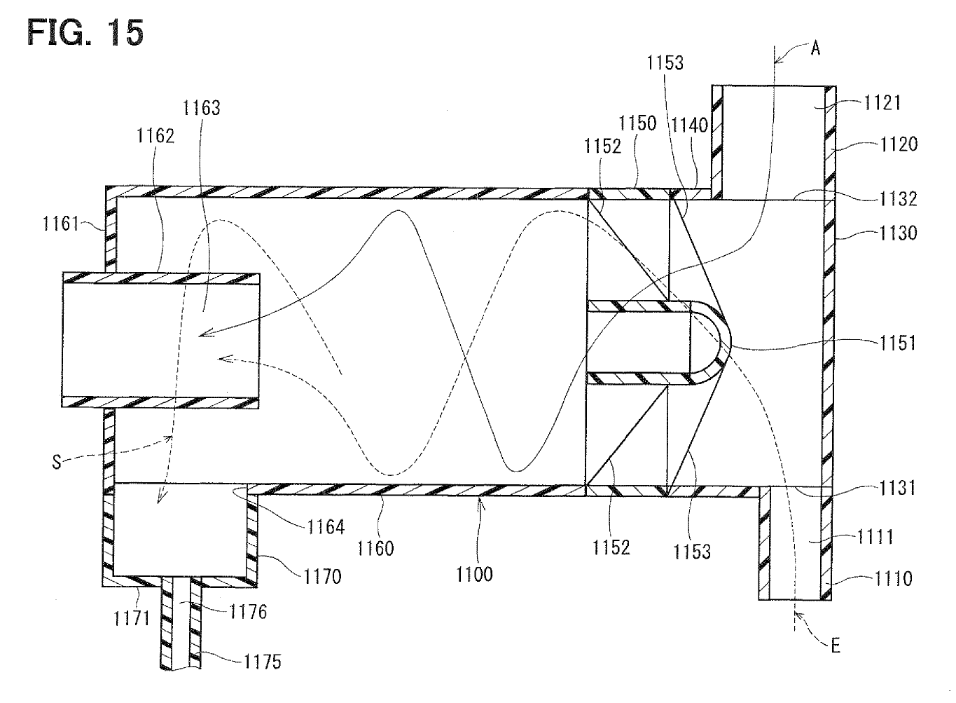

Referring to FIG. 15, flows of intake air and exhaust gas will be described. As shown by an arrow “E”, the LPL-EGR gas flows into the cylindrical portion 1130 through the LPL-EGR gas introducing passage 1111. Also, as shown by an arrow “A”, the intake air flows into the cylindrical portion 1130 through the intake air introducing passage 1121. The LPL-EGR gas and the intake air are swirled by the guide blades 152 along an inner wall surface of the mixing portion 1160. The LPL-EGR gas and the intake air are well mixed, whereby temperature unevenness will not be caused in the mixture. This mixture is introduced into the compressor housing 14 through the communication passage 1163. While swirling in the mixing portion 1160, the foreign matters are centrifugally separated and are introduced into the collecting chamber 1170 as shown by an arrow “S” in FIG. 15. The collected foreign matters in the collecting chamber 1170 are discharged into the intake passage 142 downstream of the compressor wheel 13.

### Eleventh Embodiment

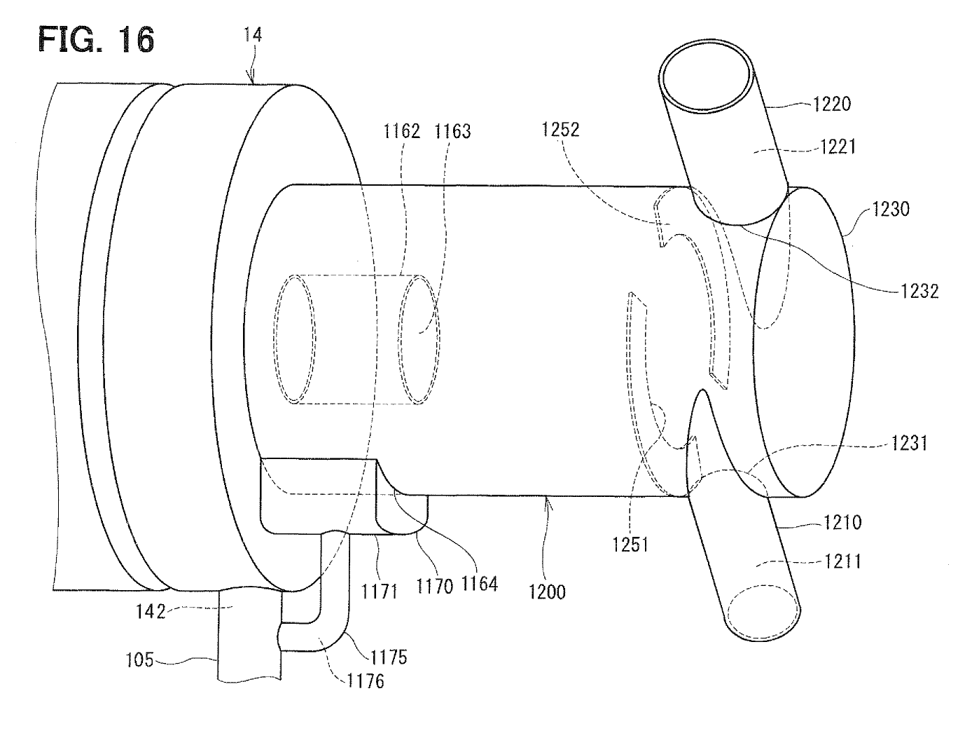

FIG. 16 is a schematic perspective view showing a swirling flow generator 1200 according to an eleventh embodiment. The swirling flow generator 1200 includes two guide plates 1251, 1252 which protrude from an inner wall surface of a cylindrical portion 1230. The first guide plate 1251 extends from a vicinity of an opening 1231 in an opposite direction relative to an LPL-EGR gas flow. The second guide plate 1252 extends from a vicinity of an opening 1232 in an opposite direction relative to an intake air flow.

The LPL-EGR gas flows into the cylindrical portion 1230 through the LPL-EGR gas introducing passage 1211. The intake air flows into the cylindrical portion 1230 through the intake air introducing passage 1221. The LPL-EGR gas and the intake air are swirled by the guide plates 1251, 1252 and are well mixed together. The centrifugally separated foreign matters are collected in the collecting chamber 1170.

### Twelfth Embodiment

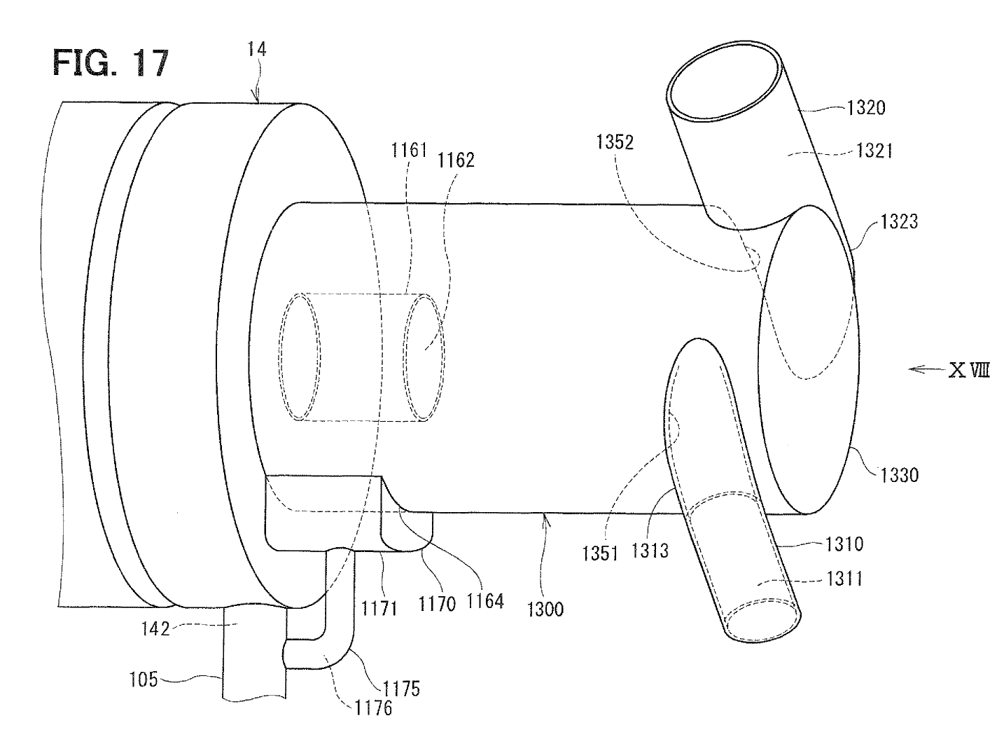

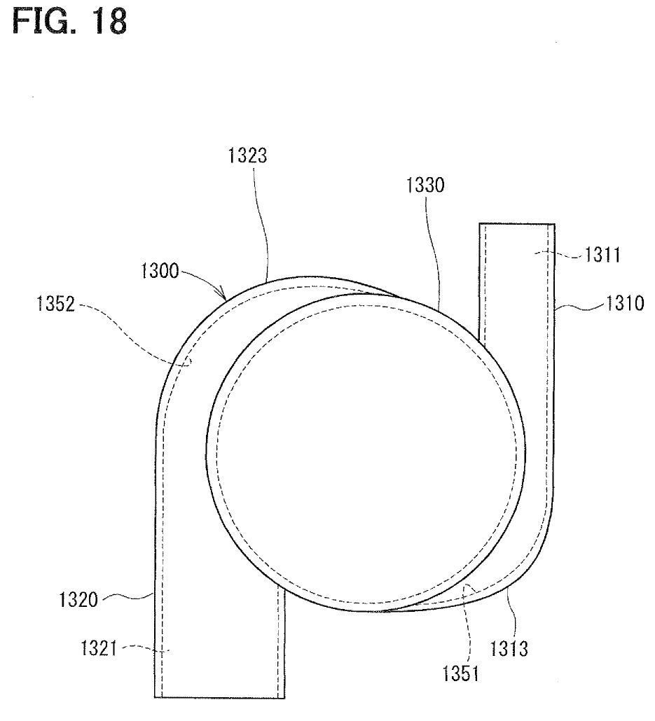

FIGS. 17 and 18 show a swirling flow generator 1300 according to a twelfth embodiment.

The swirling flow generator 1300 is provided with two guide grooves 1351, 1352. An exhaust gas introducing pipe 1310 is connected to a cylindrical portion 1330 with a radial outward deviation relative to the cylindrical portion 1330. The cylindrical portion 1330 has a first radially enlarged portion 1313. The first guide groove 1351 is formed inside of the first radially enlarged portion 1313 and continuously extends from the exhaust gas introducing pipe 1310. Similarly, an intake air introducing pipe 1320 is connected to a cylindrical portion 1330 with a radial outward deviation relative to the cylindrical portion 1330. The cylindrical portion 1330 has a second radially enlarged portion 1323. The second guide groove 1352 is formed inside of the second radially enlarged portion 1323 and continuously extends from the intake air introducing pipe 1320.

The LPL-EGR gas flows into the cylindrical portion 1330 through the LPL-EGR gas introducing passage 1311 and the first guide groove 1351. The intake air flows into the cylindrical portion 1330 through the intake air introducing passage 1321 and the second guide groove 1352. The LPL-EGR gas and the intake air are swirled by the guide grooves 1351, 1352 and are well mixed together. The centrifugally separated foreign matters are collected in the collecting chamber 1170. The collected foreign matters in the collecting chamber 1170 are discharged into the intake passage 142 downstream of the compressor wheel 13.

Alternatively, the collected foreign matters can be discharged into the exhaust pipe downstream of the turbine.

The present invention is not limited to the embodiments mentioned above, and can be applied to various embodiments.

What is claimed is:

1. An exhaust gas recirculation system for an internal combustion engine with a supercharger having a compressor, comprising:
an intake pipe for introducing an intake air into a combustion chamber of the engine;
an exhaust pipe for introducing an exhaust gas emitted from the engine;
an exhaust gas recirculation pipe recirculating the exhaust gas flowing through the exhaust pipe into the intake pipe upstream of the compressor of the supercharger;
a swirling flow generator generating a swirling flow of the intake air and the exhaust gas along an inner surface of the intake pipe in order to centrifugally separate foreign matters from the intake air and the exhaust gas;
a foreign-matters-collecting chamber collecting the centrifugally separated foreign matters therein; and
a discharge means for discharging the separated foreign matters from the foreign-matters-collecting chamber.

2. An exhaust gas recirculation system according to claim 1, wherein
the intake pipe includes a first intake pipe and a second intake pipe,
the first intake pipe has a larger inner diameter than the second intake pipe,
the first intake pipe is arranged upstream of the second intake pipe,
the foreign-matters-collecting chamber is formed between the first intake pipe and the second intake pipe, and
the swirling flow generator is arranged in the first intake pipe.

3. An exhaust gas recirculation system according to claim 2, wherein
the discharge means is a discharge opening provided to the foreign-matters-collecting chamber and a discharge pipe fluidly connected to the foreign-matters-collecting chamber through the discharge opening.

4. An exhaust gas recirculation system according to claim 1, wherein
the intake pipe is provided with a guide pipe for introducing the mixture of the intake air and the exhaust gas flowing around a center line of the intake pipe into a center portion of the compressor.

5. An exhaust gas recirculation system according to claim 4, wherein
an inner diameter of the guide pipe is smaller than an inner diameter of an inlet of the compressor.

6. An exhaust gas recirculation system for an internal combustion engine with a supercharger having a compressor, comprising:
an intake pipe for introducing an intake air into a combustion chamber of the engine;
an exhaust pipe for introducing an exhaust gas emitted from the engine;
an exhaust gas recirculation pipe recirculating the exhaust gas flowing through the exhaust pipe into the intake pipe upstream of the compressor of the supercharger;
a swirling flow generator generating a swirling flow of the intake air and the exhaust gas along an inner surface of the intake pipe in order to centrifugally separate foreign matters from the intake air and the exhaust gas; and
a discharge means for discharging the separated foreign matters outside of the intake pipe.

7. An exhaust gas recirculation system according to claim 6, wherein
the discharge means includes a discharge slit opening at a peripheral wall of the intake pipe.

8. An exhaust gas recirculation system according to claim 7, further comprising
a guide plate for guiding the separated foreign matters into the discharge slit.

9. An exhaust gas recirculation system according to claim 8, further comprising
the guide plate protruding from an inner wall of the intake pipe in such a manner as to confront the swirling flow.

10. An exhaust gas recirculation system according to claim 1, wherein
the swirling flow generator includes a plurality of fixed swirlers which fixed on an inner surface of the intake pipe.

11. An exhaust gas recirculation system according to claim 1, wherein
the swirling flow generator includes an introducing pipe having a curved passage which introduces the exhaust gas into the intake pile in a tangential direction of the peripheral wall of the intake pipe.

12. An exhaust gas recirculation system according to claim 1, wherein
the swirling flow generator includes
a first introducing pipe having a first curved passage which introduces the intake air into the intake pipe in a tangential direction of the peripheral wall of the intake pipe, and
a second introducing pipe having a second curved passage which introduces the exhaust gas into the intake pipe in the tangential direction of the peripheral wall of the intake pipe.

13. An exhaust gas recirculation system according to claim 12, wherein
the first curved passage has a curvature radius which is gradually decreased along a fluid flow, and
the second curved passage has a curvature radius which is gradually decreased along a fluid flow.

14. An exhaust gas recirculation system according to claim 1, wherein
the supercharger includes a turbine which is rotated by an exhaust gas discharged from the engine.

15. An exhaust gas recirculation system according to claim 14, wherein
the exhaust gas recirculation pipe recirculates the exhaust gas flowing through the exhaust pipe downstream of the turbine into the intake pipe upstream of the compressor of the supercharger.

16. An exhaust gas recirculation system according to claim 14, wherein
the exhaust pipe is provided with a diesel particulate filter which captures particulate matters contained in the exhaust gas flowing therethrough.

17. An exhaust gas recirculation system according to claim 16, wherein
the exhaust gas recirculation pipe recirculates the exhaust gas flowing through the exhaust pipe downstream of the diesel particulate filter into the intake pipe upstream of the compressor of the supercharger.

18. An exhaust gas recirculation system for an internal combustion engine with a supercharger having a compressor, comprising:
an intake pipe for introducing an intake air into a combustion chamber of the engine;
an exhaust pipe for introducing an exhaust gas emitted from the engine;
an exhaust gas recirculation pipe recirculating the exhaust gas flowing through the exhaust pipe into the intake pipe upstream of the compressor of the supercharger;
a swirling flow generator generating a swirling flow of the intake air and the exhaust gas along an inner surface of the intake pipe in order to centrifugally separate foreign matters from the intake air and the exhaust gas; and
a discharge means for discharging the separated foreign matters upstream of the compressor into the intake pipe downstream of the compressor while bypassing the compressor.

19. An exhaust gas recirculation system according to claim 18, wherein
the discharge means includes an ejector provided in the intake pipe downstream of the compressor and a bypass pipe connecting the intake pipe upstream of the compressor to the ejector.

20. An exhaust gas recirculation system according to claim 19, wherein
the ejector includes a nozzle through which a compressed air flows and a negative pressure generating portion generating a negative pressure around the nozzle, and
the bypass pipe connects the intake pipe upstream of the compressor to the negative pressure generating portion so that the centrifugally separated foreign matters are suctioned toward the negative pressure generating portion through the bypass pipe.

21. An exhaust gas recirculation system according to claim 20, further comprising:
an intercooler provided in the intake pipe downstream of the compressor in order to cool the compressed air, wherein
the ejector is arranged fluidly in parallel to the intercooler.
